(19) United States
(12) Patent Application Publication
(10) Pub. No.: US 2007/0251174 A1
(43) Pub. Date: Nov. 1, 2007

(54) Wood door

(76) Inventor: Min-Ju Chung, Taichung Hsien (TW)

Correspondence Address: OSTROLENK FABER GERB & SOFFEN, 1180 AVENUE OF THE AMERICAS, NEW YORK, NY, 100368403, US

(21) Appl. No.: 11/402,577

(22) Filed: Apr. 12, 2006

(51) Int. Cl. E06B 3/70

(52) U.S. Cl. 52/455

(57) ABSTRACT

A wood door includes a frame embracing a panel unit and including two transversely interconnected frame members. Each frame member includes two longitudinal components, two transverse components connected between the longitudinal components, two face plates, a first joint surface provided on one of the longitudinal components of one of the frame members, and a second joint surface provided on the longitudinal and transverse components of the other one of the frame members, and joined to the first joint surface. The transverse component of the other one of the frame members has a grain extending in a direction transverse to that of the longitudinal components of the other one of the frame members. The first and second joint surfaces extend along the direction. The one of the longitudinal components of the one of the frame members extends in the direction, and has a grain extending in the direction.

### BACKGROUND OF THE INVENTION

1. Field of the Invention

The invention relates to a wood door, more particularly to a wood door formed from a plurality of frame members.

2. Description of the Related Art

Referring to FIGS. 1 and 2, a conventional wood door 10 is shown to include two stiles 11, three rails 12 extending between and joined to the stiles 11, two vertical bars 13 extending between and joined to the corresponding rails 12, and a plurality of decorative panels 14 disposed among the stiles 11, the rails 12, and the vertical bars 13. A first joint surface 111 is provided on a longitudinally extending surface of each of the stiles 11, whereas second joint surfaces 121 are provided respectively on opposite end faces of each rail 12. First and second holes 112, 122 are respectively formed in the stiles 11 and the rails 12 to open at the first and second joint surfaces 111, 121, respectively. When assembling the stile 11 to the rail 12, glue is applied to the first and second joint surfaces 111, 121, and connecting pins 15 are extended into the corresponding first and second holes 112, 122 in the stile 11 and the rail 12. By applying a proper force to both the stile 11 and the rail 12, the stile 11 and rail 12 can be coupled together. However, the conventional wood door 10 has a major setback. For enhanced appearance, the wood grain in the stiles 11 and the rails 12 generally runs along the length thereof, i.e., the stiles 11 and the rails 12 are formed from wood that is cut lengthwise from the trunk of a tree. As the second joint surface 122 provided on the end face of the rail 12 extends crosswise with respect to the wood grain of the rail 12, the adhesive bonding of the second joint surface 122 to the first joint surface 111 is affected adversely by numerous pores 123 distributed in the second joint surface 122. After a period of use, seams between the first and second joint surfaces 111, 121 will widen to result in creaking of the wood door 10.

### SUMMARY OF THE INVENTION

Therefore, the object of the present invention is to provide a wood door formed from interconnected frame members that can be joined together firmly and that has a nice appearance.

Accordingly, a wood door of this invention includes a decorative panel unit, and a frame embracing the decorative panel unit. The frame includes at least two interconnected frame members that are transverse to each other. Each of the frame members is formed as a wood composite that includes two longitudinal components, at least one transverse component connected between the longitudinal components, and two face plates respectively covering two opposite sides of each of the longitudinal and transverse components. The frame further includes at least one first joint surface provided on one of the longitudinal components of at least one of the frame members, and at least one second joint surface provided on the longitudinal and transverse components of the other one of the frame members. The first and second joint surfaces are joined to each other. The transverse component of the other one of the frame members has a wood grain extending in a direction transverse to that of the longitudinal components of the other one of the frame members. The second joint surface extends substantially along the direction. The one of the longitudinal components of the one of the frame members extends substantially in the direction, and has a wood grain extending in the direction. The first joint surface extends substantially along the direction. Each of the face plates has a wood grain extending in a longitudinal direction of the longitudinal components.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional wood door;

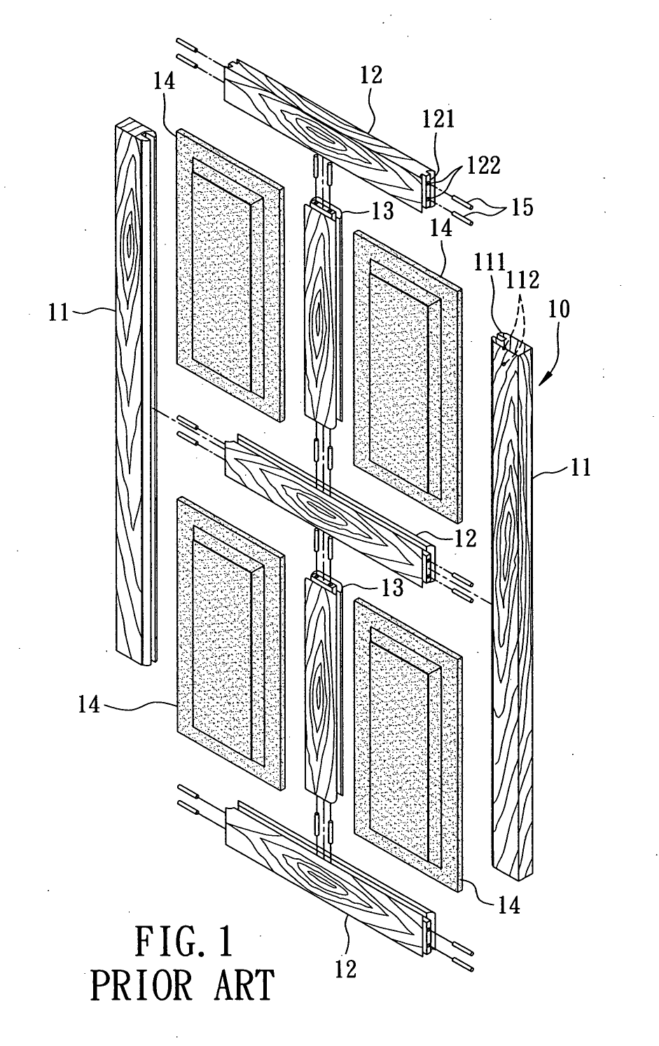

FIG. 2 is a sectional view of an end of a rail of the conventional wood door, showing a multiplicity of pores in a joint surface at an end face of the rail;

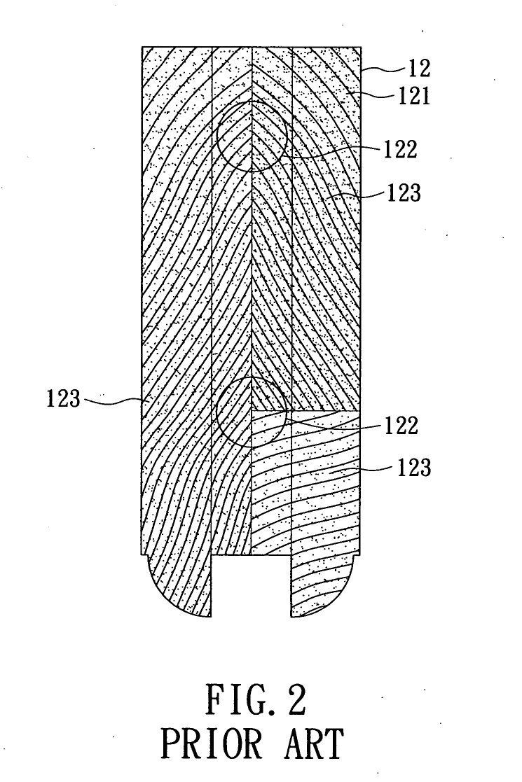

FIG. 3 is a perspective view of a preferred embodiment of a wood door according to the present invention;

FIG. 4 is a fragmentary, exploded perspective view of a frame member of the preferred embodiment, which is configured to serve as a top or bottom rail;

FIG. 5 is a fragmentary, exploded perspective view of another frame member of the preferred embodiment, which is configured to serve as a stile;

FIG. 6 is a sectional view of the preferred embodiment to illustrate the two frame members connected to each other;

FIG. 7 is a fragmentary, exploded perspective view of a frame member of the preferred embodiment, which is configured to serve as a vertical bar; and

FIG. 8 is a sectional view of the preferred embodiment to illustrate the frame member of FIG. 7 connected to another frame member that is configured to serve as an intermediate rail.

### DETAILED DESCRIPTION OF THE PREFERRED EMBODIMENT

Before the present invention is described in greater detail, it should be noted that like elements are denoted by the same reference numerals throughout the disclosure.

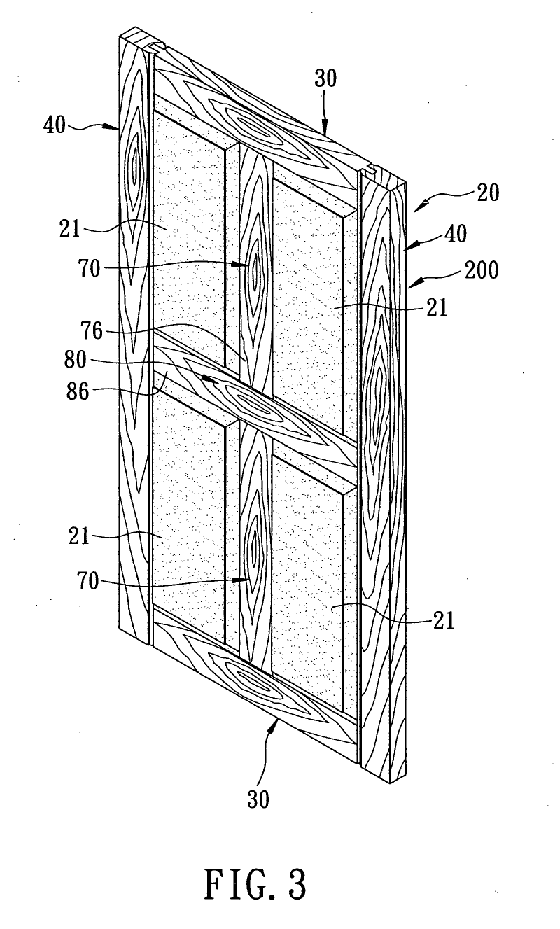

Referring to FIG. 3, the preferred embodiment of a wood door 20 according to the present invention is shown to include a four-sided frame 200 which embraces a decorative panel unit including four decorative panels 21. The frame 200 includes a plurality of frame members 30, 40, 70, 80 each formed as a wood composite. While the frame 200 has all of its frame members 30, 40, 70, 80 formed as wood composites in this embodiment, at least two interconnected frame members 30, 40, 70, 80 may be formed as wood composites according to the present invention.

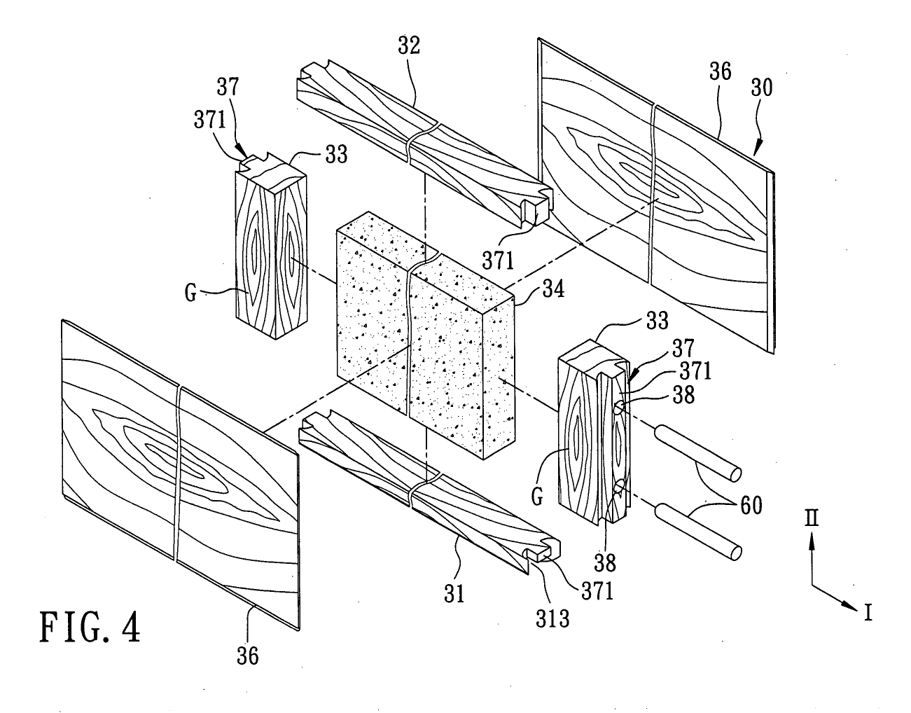

Referring to FIG. 4, the wood composite of each frame member 30 includes two longitudinal components 31, 32 extending in a horizontal direction (I), two transverse components 33 which are connected between the longitudinal components 31, 32, and two face plates 36 respectively covering two opposite sides of each of the longitudinal and transverse components 31, 32, 33. A filler 34 is disposed between the transverse components 33, between the longitudinal components 31, 32, and between the face plates 36. In this embodiment, the frame member 30 is a top or bottom rail, and each transverse component 33 has a wood grain (G) extending in a vertical direction (II) which is transverse to that of the longitudinal components 31 32. Furthermore, the longitudinal component 31 has a panel engaging groove 313 formed therein for engaging a corresponding one of the decorative panels 21. For enhanced appearance, the face plates 36 have a wood grain extending in a longitudinal direction of the longitudinal components 31, 32, i.e., in the horizontal direction (I).

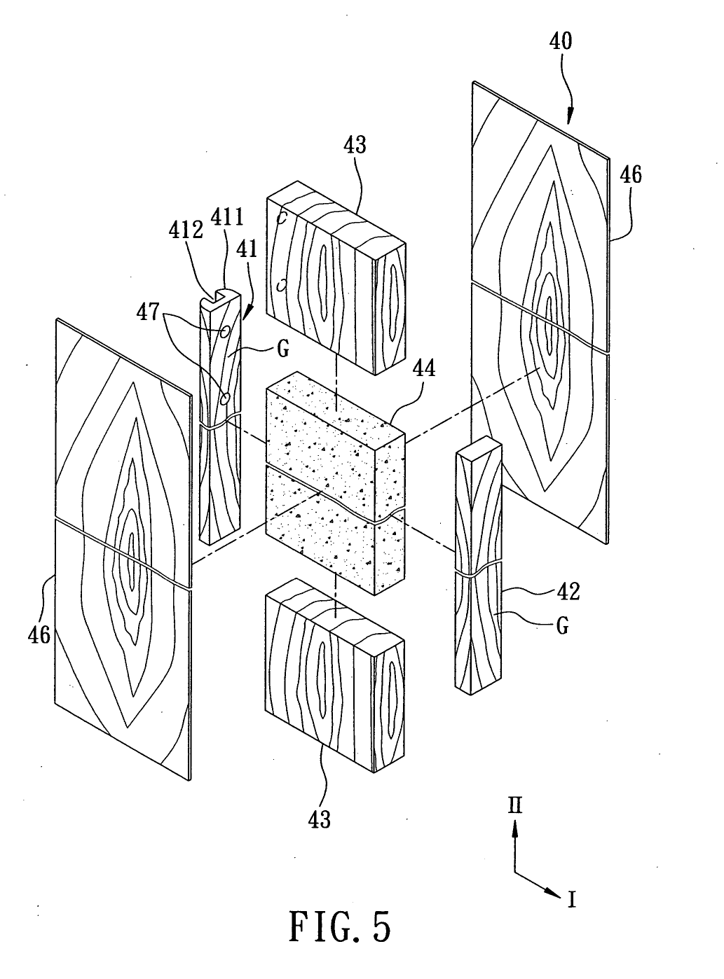

Referring to FIG. 5, the wood composite of each frame member 40 includes two longitudinal components 41, 42, two transverse components 43 which are connected between the longitudinal components 41, 42, and two face plates 46 respectively covering two opposite sides of each of the longitudinal and transverse components 41, 42, 43. A filler 44 is disposed between the transverse components 43, between the longitudinal components 41, 42, and between the face plates 46. In this embodiment, the frame member 40 is a stile, and the longitudinal components 41, 42 have a wood grain (G) extending substantially in the vertical direction (II). Likewise, for enhanced appearance, the face plates 46 have a wood grain extending in a longitudinal direction of the longitudinal components 41, 42, i.e., in the vertical direction (II).

A first joint surface 411 is provided on the longitudinal component 41 of the frame member 40, and extends substantially from top to bottom of the longitudinal component 41 in the vertical direction (II) in the direction of the wood grain (G). There are two second joint surfaces 37 on two opposite ends of the frame member 30, as best shown in FIG. 4. Each second joint surface 37 is provided on one of two opposite ends of each of the longitudinal components 31, 32, and one of two opposite ends of each of the transverse components 33 of the frame member 30, and extends substantially in the vertical direction (II), i.e., in the direction of the wood grain (G).

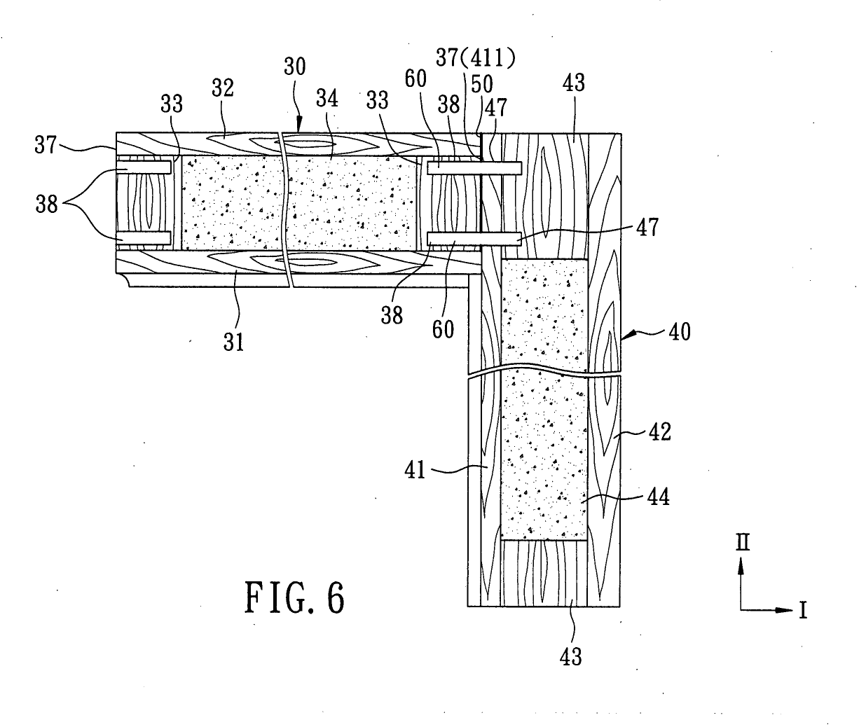

Furthermore, two first holes 47 are formed in the longitudinal component 41 of the frame member 40, and open at the first joint surface 411, as best shown in FIG. 5. Two second holes 38 are formed in each end of the transverse component 33 of the frame member 30, and open at the corresponding second joint surface 37, as best shown in FIG. 4. Two connecting pins 60 are each inserted into one of the first holes 47 and one of the second holes 38, as best shown in FIG. 6.

In this embodiment, each second joint surface 37 has tongues 371 (see FIG. 4) projecting from the corresponding transverse component 33 of the frame member 30. The first joint surface 411 has a groove 412 (see FIG. 5) formed in the longitudinal component 41 of the frame member 40 to interlock with the tongues 371. Each of the second holes 38 extends through the tongue 371. It is noted that the tongue 371 and the groove 412 can be interchangeably provided on the first and second joint surfaces 411, 37.

Each filler 34, 44 includes a composite material that contains a binder and wood fibers for reducing fabrication costs. It is noted that, except the fillers 34, 44, the longitudinal and transverse components 31, 32, 33, 41, 42, 43, as well as the face plates 36, 46, of the frame members 30, 40 are all made from solid wood.

To join the frame members 30, 40, glue 50 is applied to the second joint surface 37 on the frame member 30, and one end of each of the connecting pins 60 is inserted into the corresponding first hole 38. Then, the frame member 40 is moved toward the frame member 30 such that the other ends of the connecting pins 60 fit into the holes 47 and such that the groove 412 engages the tongues 371. By applying a force to the frame members 30, 40, the frame members 30, 40 can be joined together firmly, as best shown in FIG. 6. It is noted that since the second joint surface 37 extends in the direction of the wood grain (G), as is the first joint surface 411, the joining effect of the frame members 30, 40 can be enhanced.

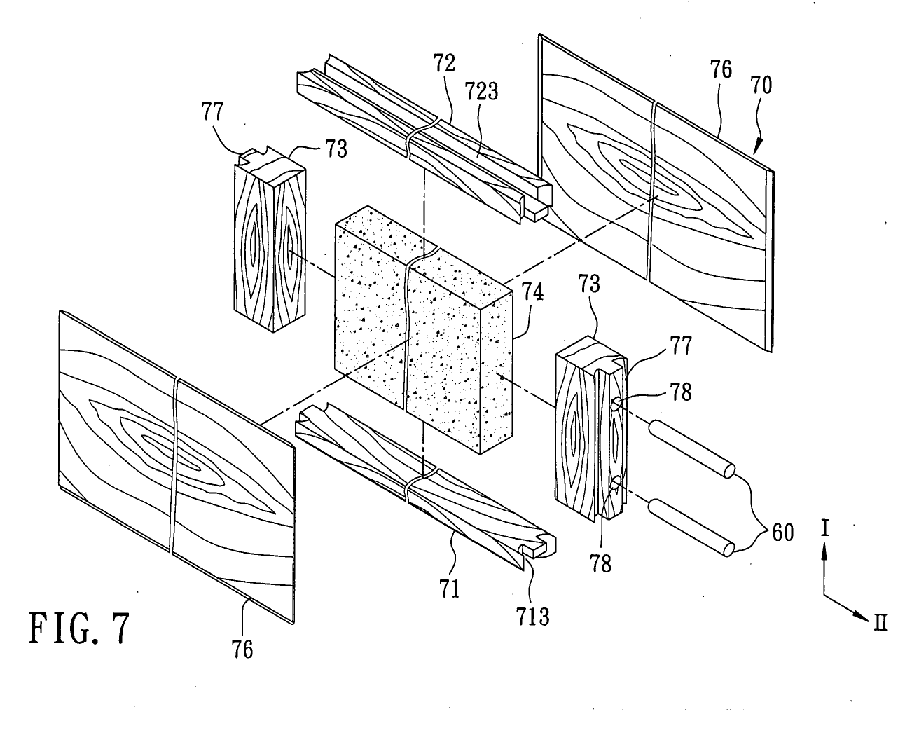

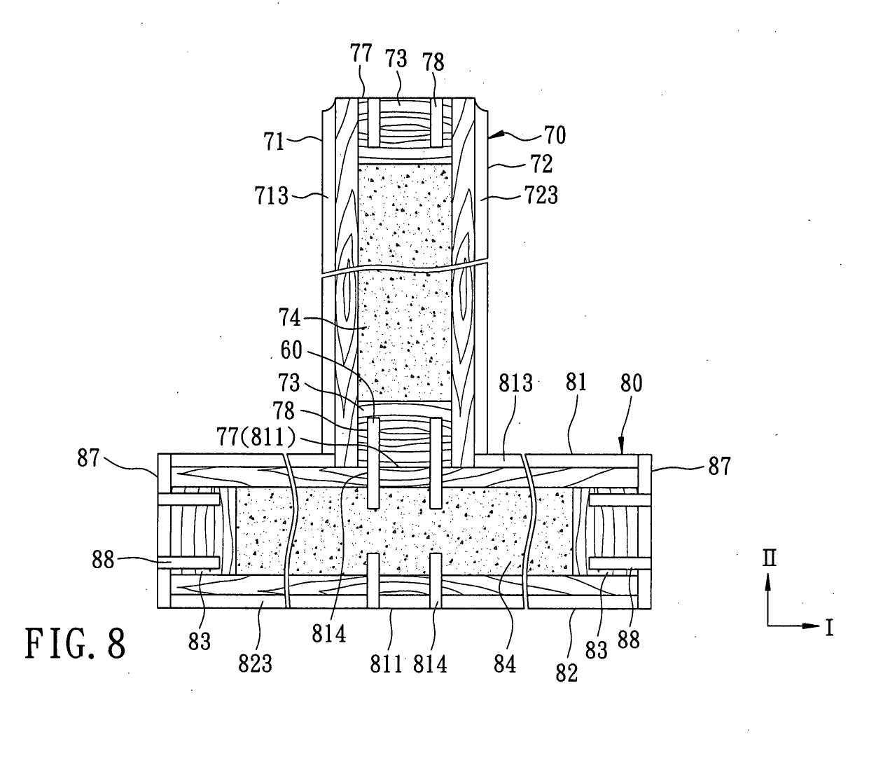

Referring to FIGS. 7 and 8, like the frame members 30, 40, the frame member 70 includes two longitudinal components 71, 72, two transverse components 73, two face plates 76, and a filler 74. A pair of the second joint surfaces 77, which are the same as the second joint surfaces 37, are formed on the frame member 70. The second holes 78 open at each second joint surface 77. Furthermore, each of the longitudinal components 71, 72 of the frame member 70 is provided with the panel engaging groove 713, 723 for engaging the decorative panels 21 (see FIG. 3) to the left and right sides of the frame member 70.

The frame member 80 also includes two longitudinal components 81, 82, two transverse components 83, two face plates 86 (see FIG. 3), and a filler 84. Two first joint surfaces 811 which are the same as the first joint surface 411 are provided on an intermediate part of the frame member 80. Further, two second joint surfaces 87 which are the same as the second joint surfaces 37 are provided on the frame member 80. Second holes 88 open at the second joint surfaces 87, whereas first holes 814 open at the first joint surfaces 811. In addition, each of the longitudinal components 81, 82 has a panel engaging groove 813, 823 for engaging the decorative panels 21 (see FIG. 3) adjacent thereto.

Referring once again to FIG. 8, one of the second joint surfaces 77 on the frame member 70 is joined to one of the first joint surfaces 811 on the frame member 80. Connecting pins 60 are inserted into the first and second holes 814, 78. Referring again to FIGS. 3 and 8, the other second joint surface 77 is to be joined to an intermediate part of the top frame member 30. The two second joint surfaces 87 are to be joined to intermediate parts of two frame members 40.

In sum, since the first and second joint surfaces 411, 811, 37, 77, 87 extend in the directions of the wood grains (G), the joints among the frame members 30, 40, 70 and 80 of the wood door 20 are more robust compared with the conventional wood door 10. Besides, as the face plates 36, 86 of the frame members 30, 80 are configured to have horizontally extending wood grains, whereas the face plates 46, 76 of the frame members 40, 70 are configured to have vertically extending wood grains, the appearance of the wood door 20 is comparable to that of the conventional wood door 10 which is entirely made from solid wood.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A wood door comprising:
a decorative panel unit; and
a frame embracing said decorative panel unit, said frame including at least two interconnected frame members that are transverse to each other;
each of said frame members being formed as a wood composite that includes two longitudinal components, at least one transverse component connected between said longitudinal components, and two face plates respectively covering two opposite sides of each of said longitudinal and transverse components;
said frame further including at least one first joint surface provided on one of said longitudinal components of at least one of said frame members, and at least one second joint surface provided on said longitudinal and transverse components of the other one of said frame members, said first and second joint surfaces being joined to each other;
said transverse component of said other one of said frame members having a wood grain extending in a direction transverse to that of said longitudinal components of said other one of said frame members, said second joint surface extending substantially along said direction;
said one of said longitudinal components of said one of said frame members extending substantially in said direction and having a wood grain extending in said direction, said first joint surface extending substantially along said direction;
each of said face plates having a wood grain extending in a longitudinal direction of said longitudinal components.

2. The wood door of claim 1, wherein said frame further includes two connecting pins, two first holes formed in said one of said longitudinal components of said one of said frame members and opening at said first joint surface, two second holes formed in said transverse component of said other one of said frame members and opening at said second joint surface, each of said connecting pins being inserted into one of said first holes and one of said second holes.

3. The wood door of claim 2, wherein said second joint surface has a tongue projecting from said transverse component of said other one of said frame members, said first joint surface having a groove formed in said one of said longitudinal components to interlock with said tongue, each of said second holes extending through said tongue, each of said first holes being connected to said groove.

4. The wood door of claim 1, wherein each of said frame members includes a pair of said transverse components each of which is connected to one of two opposite ends of each of said longitudinal components.

5. The wood door of claim 4, wherein each of said frame members further includes a filler disposed between said transverse components, between said longitudinal components, and between said face plates.

6. The wood door of claim 4, wherein said filler includes a composite material that contains a binder and wood fibers.

7. The wood door of claim 4, wherein at least one of said longitudinal components of each of said frame members has a panel engaging groove.
